(19) United States
(12) Patent Application Publication
(10) Pub. No.: US 2025/0155391 A1
(43) Pub. Date: May 15, 2025

(54) METHOD, SYSTEM, AND DEVICE FOR MEASURING THERMAL CONDUCTIVITY OF TISSUE

(71) Applicants: Samsung Electronics Co., Ltd., Suwon-si (KR); UIF (University Industry Foundation), Yonsei University, Seoul (KR)

(72) Inventors: Boksoon KWON, Suwon-si (KR); Woochul KIM, Seoul-si (KR); Sang Kyu KIM, Suwon-si (KR); Gimin PARK, Seoul-si (KR)

(73) Assignees: Samsung Electronics Co., Ltd., Suwon-si, Gyeonggi-do (KR); UIF (University Industry Foundation), Yonsei University, Seoul (KR)

(21) Appl. No.: 18/931,876

(22) Filed: Oct. 30, 2024

(30) Foreign Application Priority Data
Nov. 10, 2023 (KR) 10-2023-0155720
Apr. 30, 2024 (KR) 10-2024-0058129

(51) Int. Cl. G01N 25/18; G01K 13/20; G01K 15/00; G01N 25/00

(52) U.S. Cl. CPC G01N 25/18; G01K 13/20; G01K 15/005; G01N 25/005

(57) ABSTRACT

Provided are a method and a system, for measuring thermal conductivity of tissue. A method of measuring thermal conductivity of tissue by using a device including a heating device and a temperature sensor includes applying a first heat flow including constant heat flow to the tissue, generating first temperature data by sensing a temperature change in the tissue as the first heat flow is applied thereto, applying a second heat flow including a sinusoidal heating method to the tissue, generating second temperature data by sensing a temperature change in the tissue as the second heat flow is applied thereto, and based on the first temperature data and the second temperature data, deriving inherent thermal conductivity of the tissue by considering heat transfer due to blood perfusion within the tissue.

### CROSS-REFERENCE TO RELATED APPLICATIONS

This application is based on and claims priority under 35 U.S.C. § 119 to Korean Patent Application Nos. 10-2023-0155720, filed on Nov. 10, 2023, and 10-2024-0058129, filed on Apr. 30, 2024, in the Korean Intellectual Property Office, the disclosures of which are incorporated by reference herein in their entireties.

### BACKGROUND

The inventive concepts relate to a method of measuring thermal conductivity, and more particularly, to a method and a system, for measuring thermal conductivity of tissue.

Thermal conductivity (which is a measure of the ability of a substance or object to transfer heat) may vary depending on the material, physical properties, and composition thereof. Tissue of living organisms, such as humans, also have inherent thermal conductivity. However, in the case of living tissue, heat transfer may occur due to blood perfusion, making it difficult to measure inherent thermal conductivity thereof. Therefore, a methodology for measuring inherent thermal conductivity of tissue itself by considering heat transfer due to blood perfusion has emerged without using invasive methods such as incision or penetration.

### SUMMARY

The inventive concepts provide a method and a system for measuring inherent thermal conductivity of tissue by considering heat transfer due to blood perfusion.

According to an aspect of the inventive concepts, there is provided a method of measuring thermal conductivity of tissue using a device including a heating device and a temperature sensor, the method including applying a first heat flow to the tissue, the first heat flow including a constant heat flow; generating first temperature data by sensing a temperature change in the tissue as the first heat flow is applied; applying a second heat flow to the tissue, the second heat flow including a sinusoidal heat flow; generating second temperature data by sensing a temperature change in the tissue as the second heat flow is applied; and deriving inherent thermal conductivity of the tissue based on the first temperature data, the second temperature data, and heat transfer due to blood perfusion within the tissue.

According to another aspect of the inventive concepts, there is provided a system for measuring thermal conductivity of tissue, the system including a heating device configured to apply a first heat flow including constant heat flow and a second heat flow including a sinusoidal heating method to the tissue, a temperature sensor configured to generate first temperature data by sensing a temperature change in the tissue as the first heat flow is applied and to generate second temperature data by sensing a temperature change in the tissue as the second heat flow is applied, and a computing device configured to derive inherent thermal conductivity of the tissue based on the first temperature data, the second temperature data, and heat transfer due to blood perfusion within the tissue.

According to another aspect of the inventive concepts, there is provided a device for measuring thermal conductivity of tissue, the device including a heating device configured to apply a first heat flow including constant heat flow and a second heat flow including a sinusoidal heating method to the tissue, a temperature sensor configured to generate first temperature data by sensing a temperature change in the tissue as the first heat flow is applied and to generate second temperature data by sensing a temperature change in the tissue as the second heat flow is applied, and an interface circuit configured to transmit the first temperature data and the second temperature data to an outside computing device to enable the outside computing device to derive inherent thermal conductivity of the tissue based on the first temperature data, the second temperature data, and heat transfer due to blood perfusion within the tissue.

### BRIEF DESCRIPTION OF THE DRAWINGS

Embodiments will be more clearly understood from the following detailed description taken in conjunction with the accompanying drawings in which:

FIG. 1 is a block diagram of a system according to at least one embodiment;

FIG. 2 is a block diagram of a system including a device according to at least one embodiment;

FIG. 3 is a diagram showing the effect of blood perfusion within tissue, according to at least one embodiment;

FIG. 4 is a diagram illustrating a device performing a method of measuring thermal conductivity of tissue, according to at least one embodiment;

FIG. 5A is a graph showing a first heat flow including constant heat flow, according to at least one embodiment;

FIG. 5B is a graph showing a second heat flow including a sinusoidal heating method according to at least one embodiment;

FIG. 6 is a graph showing an example of sequentially applying a first heat flow and a second heat flow to tissue, according to at least one embodiment;

FIG. 7A is a diagram of a device according to at least one embodiment;

FIG. 7B is a diagram showing heat flow due to heat generation of a device according to at least one embodiment;

FIG. 8 is a diagram showing a temperature change due to heat generation of a device according to at least one embodiment;

FIG. 9 is a diagram showing a temperature change due to application of a second heat flow to tissue, according to at least one embodiment;

FIG. 10 is a flowchart of a method of measuring thermal conductivity of tissue, performed by a system, according to at least one embodiment;

FIG. 11 is a flowchart of a method of measuring thermal conductivity of tissue, performed by a system, according to at least one embodiment;

FIG. 12 is a flowchart of a method of measuring thermal conductivity of tissue, performed by a system, according to at least one embodiment; and

FIG. 13 is a flowchart of a method of measuring thermal conductivity of tissue, performed by a system, according to at least one embodiment.

### DETAILED DESCRIPTION OF THE EMBODIMENTS

Hereinafter, embodiments are described in detail with reference to the accompanying drawings.

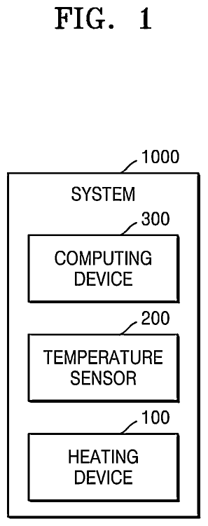

FIG. 1 is a block diagram of a system according to at least one embodiment.

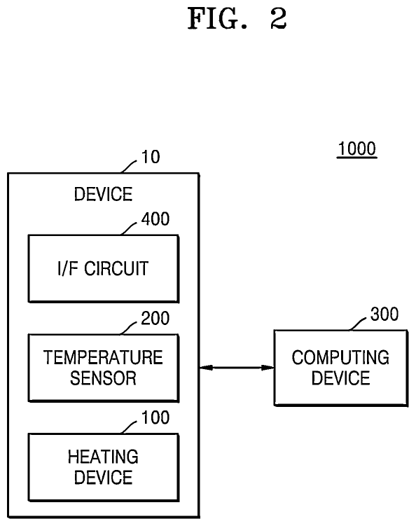

The system 1000 may include a system for measuring thermal conductivity of tissue and include a heating device 100, a temperature sensor 200, and a computing device 300. The system 1000 according to at least one embodiment may be implemented as a single system on chip (SoC) including the computing device 300. In addition, as will be described below with reference to FIG. 2, the system 1000 may be configured as a whole including the device 10 including the heating device 100 and the temperature sensor 200, and/or the computing device 300 connected to the device 10 from outside the device 10. That is, the computing device 300 constituting the system 1000 may be located outside the device 10 and connected to the device 10 and/or may be implemented as a single SoC. Components included in the system 1000 may be communicatively connected to each other, for example, through a bus configured to enable one-way and/or two-way and/or through broadcast communication with respect to each other in order to exchange and/or receive information.

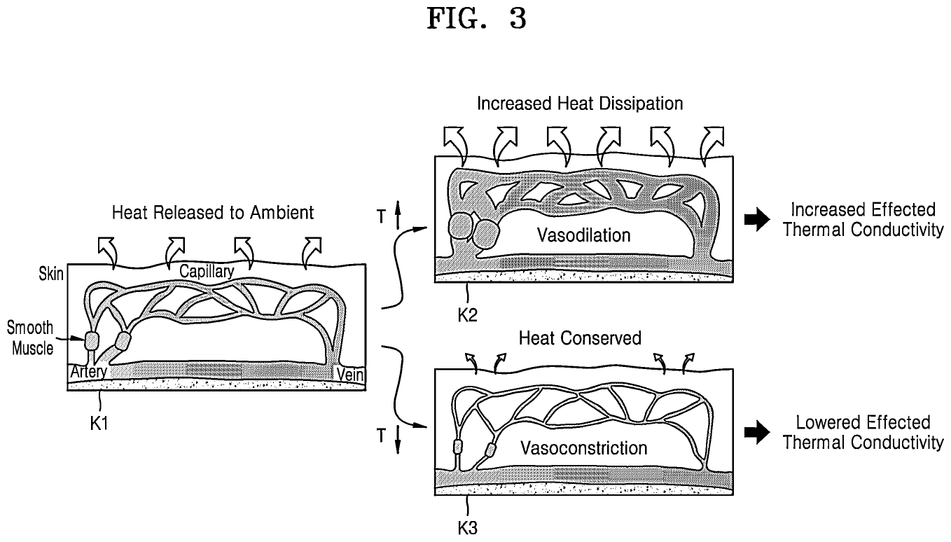

Tissue (which is a part of the body of animals, such as humans) may be the subject of thermal conductivity measurement according to some embodiments. Details regarding tissue are described below with reference to FIG. 3.

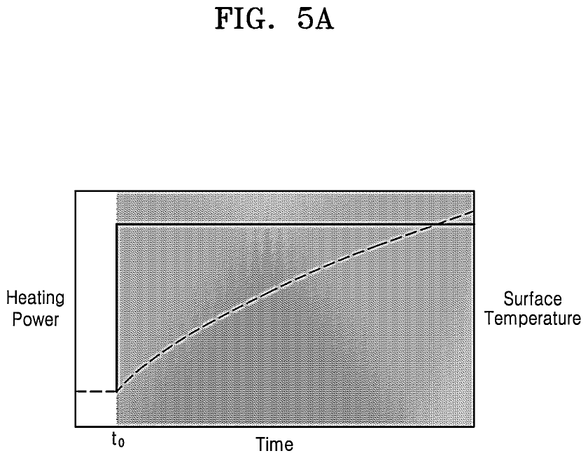

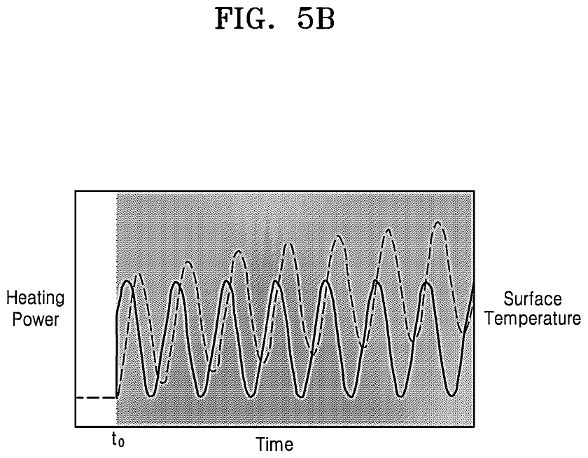

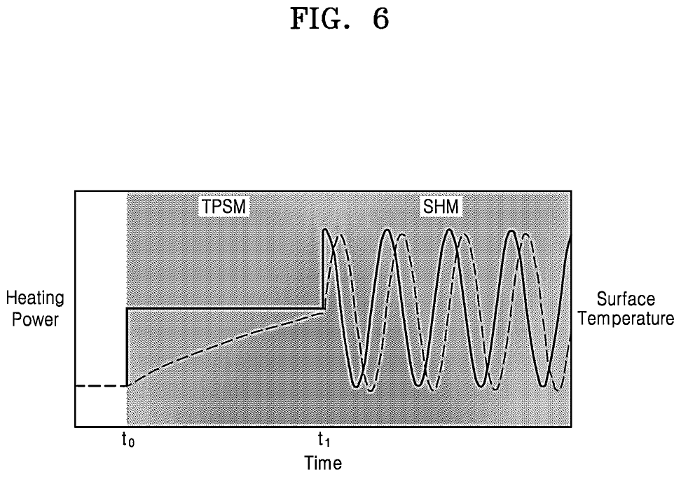

The heating device 100 may be configured to generate heat flow to be transmitted to a measurement object (e.g., tissue) to measure thermal conductivity thereof. The heating device 100 may also be referred to as a heating unit, a heater, a heat pump, etc. The heating device 100 according to at least one embodiment may be formed in a plate shape and may consume and convert power into heat energy. The heating device 100 may come into contact with the measurement object and apply the heat flow to the surface of the measurement object. The heating device 100 may generate the heat flow according to a command of the computing device 300 and/or according to a method stored internally. For example, the heating device 100 may apply constant heat flow to the measurement object. Additionally, the heating device 100 may apply the heat flow according to a sinusoidal heating method to the measurement object. The heating method of the heating device 100 may be described in detail below with reference to FIGS. 5A, 5B, and 6.

The temperature sensor 200 may be configured to measure the temperature of the measurement object that changes as the heat flow from the heating device 100 is applied to the measurement object. The temperature sensor 200 may contact the measurement object to measure the surface temperature of the measurement object. The temperature sensor 200 may be formed along the outer boundary of the heating device 100 and configured to measure the temperature of the measurement object or may be formed in the central portion of the heating device 100 and configured to measure the temperature of the measurement object. In addition, the temperature sensor 200 may be formed in another location and the temperature sensor 200 may be located in an appropriate location where the heating device 100 can measure the surface of the measurement object through which the heat flow is transmitted. The temperature sensor 200 may generate temperature data by measuring the surface temperature of the measurement object over time. The generated temperature data may be transmitted to the computing device 300.

The computing device 300 may be configured to control the overall operation of the system 1000, and more specifically, the operation of other components forming the system 1000. For example, the computing device 300 may control the start and end of heating of the heating device 100 and may control the heating method, the heating degree, and the applied power. Additionally, the computing device 300 may control the temperature sensor 200 to measure the temperature of the measurement object and may also receive temperature data from the temperature sensor 200. In at least one embodiment, the computing device 300 may be implemented is (and/or as) processing circuitry such as, hardware, software, or a combination of hardware and software. For example, the processing circuitry may include, but is not limited to, including a general-purpose processor, a dedicated processor, an application processor, a digital signal processor, a microcomputer, a field programmable gate array (FPGA), a System-on-Chip (SoC) a programmable logic unit, a microprocessor, etc. In addition, the computing device 300 may be implemented including a computational processor (e.g., central processing unit (CPU), graphics processing unit (GPU), application processor (AP), etc.) including dedicated logic circuits (e.g., an arithmetic logic unit (ALU), field programmable gate arrays (FPGAs), application specific integrated circuits (ASICs), etc.).

The system 1000 including the heating device 100, the temperature sensor 200, and the computing device 300 may perform a method of measuring thermal conductivity of tissue. The heating device 100 may sequentially apply a first heat flow including constant heat flow and a second heat flow including a sinusoidal heating method to the tissue. The temperature sensor 200 may generate first temperature data by sensing the temperature change in the tissue as the first heat flow is applied thereto and may generate second temperature data by sensing the temperature change in the tissue as the second heat flow is applied thereto. Based on the received first temperature data and the second temperature data, the computing device 300 may derive the inherent thermal conductivity of the tissue by considering heat transfer due to blood perfusion within the tissue. Additionally, the system 1000 may perform a method of measuring thermal conductivity of tissue, according to at least one embodiment, to be described below.

FIG. 2 is a block diagram of a system including a device according to at least one embodiment.

Hereinafter, FIG. 2 is described with reference to FIG. 1 and overlapping descriptions with those described with reference to FIG. 1 are omitted. As described above with reference to FIG. 1, the computing device 300 constituting the system 1000 may be located outside the device 10 and connected to the device 10 (and/or may be implemented as a single SoC). Referring to FIG. 2, the system 1000 may be configured as a whole including the computing device 300 connected to the device 10 from outside the device 10. That is, the system 1000 of FIG. 2 according to the embodiment may include the device 10 and the computing device 300. The device 10 may include the heating device 100, the temperature sensor 200, and an interface circuit 400.

The device 10 may be configured to be attached to an object of which thermal conductivity is to be measured, for example, tissue. The device 10 may apply heat flow to tissue through the heating device 100. Additionally, the device 10 may measure the temperature change in the tissue to which the heat flow is applied through the temperature sensor 200.

The device 10 may be connected to the computing device 300 through the interface circuit 400. The device 10 and the computing device 300 may be connected (e.g., through a wired or wireless connection) to exchange data. The interface circuit 400 may connect the computing device 300 to the device 10 to receive and transmit data. For example, the interface circuit 400 may receive commands related to operation control of the heating device 100 and the temperature sensor 200 from the computing device 300. The interface circuit 400 may be configured to transmit the received commands to the heating device 100 and the temperature sensor 200 so that the heating device 100 and the temperature sensor 200 perform operations according to the commands. For example, the device 10 may receive a command to start measuring thermal conductivity of tissue from the computing device 300 through the interface circuit 400. Upon receiving the command to start measuring thermal conductivity of tissue, temperature data may be generated through application of heat flow by the heating device 100 and measurement of tissue temperature by the temperature sensor 200. The generated temperature data may be transmitted to the computing device 300 through the interface circuit 400. The computing device 300 may derive the inherent thermal conductivity of the tissue based on data, such as received temperature data.

The device 10 including the heating device 100, the temperature sensor 200, and the interface circuit 400 may perform a method of measuring thermal conductivity of tissue together with the computing device 300. The heating device 100 may sequentially apply a first heat flow including constant heat flow and a second heat flow including a sinusoidal heating method to the tissue. The temperature sensor 200 may generate first temperature data by sensing the temperature change in the tissue as the first heat flow is applied thereto and may generate second temperature data by sensing the temperature change in the tissue as the second heat flow is applied thereto. The interface circuit 400 may transmit the first temperature data and the second temperature data to the outside computing device 300 to allow the outside computing device 300 to derive the inherent thermal conductivity of tissue by considering heat transfer due to blood perfusion within the tissue based on the first temperature data and the second temperature data.

According to the above-described embodiment, the inherent thermal conductivity of the tissue itself may be measured by considering heat transfer due to blood perfusion without using invasive methods, such as incision or penetration. In addition, the inherent thermal conductivity of tissue may be derived by correcting the effect of heat transfer due to blood perfusion while performing in vivo thermal conductivity measurement.

FIG. 3 is a diagram showing the effect of blood perfusion within tissue according to at least one embodiment.

Hereinafter, FIG. 3 is described with reference to the above-described drawings and overlapping descriptions with those described above are omitted.

Tissue which is a part of the body of animals, such as humans, may be the subject of thermal conductivity measurement according to some embodiments. Tissue of living organisms, such as humans, may have inherent thermal conductivity, like other materials or objects. However, in the case of living tissue, at least a portion of the heat transfer may occur due to blood perfusion, making measurement of the inherent thermal conductivity of tissue difficult. For example, although the measurement of the inherent thermal conductivity of tissue is performed, heat transfer due to blood perfusion may occur and the measured thermal conductivity may, therefore, be different from the actual inherent thermal conductivity of tissue.

When there is no liquid perfusion, such as blood, and no internal energy generation, Fourier's law of conduction, which is an equation for thermal conductivity in one direction, may be structured as shown in Equation 1 below.

$$q = \frac{kA}{l} Δ T \qquad [ Equation 1 ]$$

In Equation 1, q is an amount of heat transfer (W), A is a cross-sectional area, l is a thickness, ΔT is a temperature difference, and k is a thermal conductivity (W/m·K).

In the case where there is no internal energy generation, the heat conduction equation in one direction may be structured as shown in Equation 2 below.

$$ρ {c}_{p} \frac{\partial T}{\partial t} = {k}_{eff} \frac{{\partial }^{2} T}{\partial {x}^{2}} \qquad [ Equation 2 ]$$

In Equation 2, ρ is a density, cₚ is a specific heat, T is a temperature, t is a time, k_{eff} is an effective thermal conductivity, and x is a distance. Therefore, thermal conductivity of materials, such as general objects or metal samples, may be measured by applying heat flow thereto in one direction and measuring the temperature thereof.

However, as described above, in the case of living tissue, heat transfer may occur due to blood perfusion and thus the measured thermal conductivity thereof may be different from the actual inherent thermal conductivity of the tissue. In other words, the effective thermal conductivity may be affected by the heat transfer due to blood perfusion rather than the inherent thermal conductivity of tissue.

The thermal conductivity of the tissue may be measured by collecting tissue samples and removing blood. However, due to the nature of tissue, if the tissue is not living tissue, the physical properties, such as thermal conductivity, thereof may change. In addition, measuring the thermal conductivity of tissue through an invasive method may also cause heat transfer due to blood perfusion and/or may damage the tissue. As the tissue is destroyed, physical properties, such as thermal conductivity, thereof may change. Therefore, to measure the inherent thermal conductivity of tissue in vivo and noninvasively, heat transfer due to blood perfusion may need to be considered.

In other words, Penne's bioheat equation, rather than Equation 2 above, may be applied to the thermal energy governing equation corresponding to living tissue. Penne's bioheat equation may be structured as shown in Equation 3 below.

$$ρ {c}_{p} \frac{\partial T}{\partial t} = k \frac{{\partial }^{2} T}{\partial {x}^{2}} + {ω}_{b} {ρ}_{b} {c}_{p , b} ( {T}_{a} - T ) + {q}_{m}^{′′′} \qquad [ Equation 3 ]$$

In Equation 3, k is an inherent thermal conductivity, ωₚ is a blood perfusion rate (/s), ρ_{b} is a density of blood, c_{p,b} is a specific heat of blood, qₘ′″ is an amount of heat generated by metabolism, and T_{α} is a temperature of arterial blood. The second term on the right side of Equation 3 may include a term considering heat transfer due to blood perfusion and the third term on the right side of Equation 3 may include a term considering heat generation due to metabolism. In areas far from the core (e.g., forearms, hands, calves, feet, etc.), the amount of metabolism is relatively small and can be ignored. However, the blood perfusion may need to be considered because the amount of calories thereof is not small.

Referring to FIG. 3, a first state K1 of tissue represents a state of tissue in a normal body temperature state, according to at least one embodiment. In comparison, a second state K2 represents a state in which the body temperature is increased, compared to the normal body temperature state, and a third state K3 represents a state in which the body temperature is decreased, compared to the normal body temperature state. In the second state K2, vasodilation may occur as body temperature rises and thus the amount of heat transfer due to blood perfusion may increase. As a result, the increase in body temperature may result in an increase in effective thermal conductivity. Conversely, in the case of the third state K3, vasoconstriction may occur as body temperature decreases and thus the amount of heat transfer due to blood perfusion may decrease. As a result, the decrease in body temperature may result in a decrease in effective thermal conductivity.

When the thermal conductivity of tissue is not measured considering heat transfer due to blood perfusion, the effective thermal conductivity k_{eff} that reflects the influence of heat transfer due to blood perfusion may be derived, rather than the inherent thermal conductivity k of tissue, which is not affected by heat transfer due to blood perfusion. Due to the above-mentioned effects of vasodilation and vasoconstriction, the effective thermal conductivity k_{eff}, which reflects the influence of heat transfer due to blood perfusion, may tend to increase as temperature increases. On the other hand, since the inherent thermal conductivity k of tissue, which is derived according to a measurement method to be described below, is not affected by heat transfer due to blood perfusion, a constant thermal conductivity value may be achieved, unlike the increase in temperature.

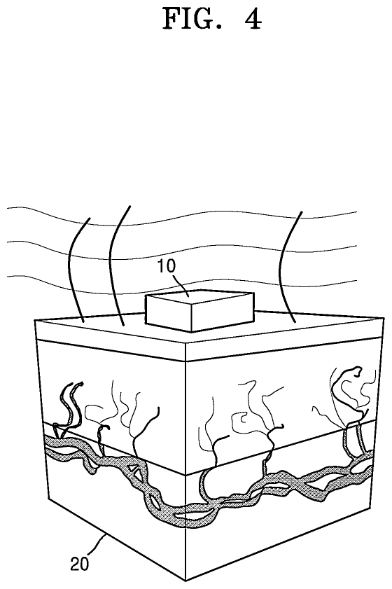

FIG. 4 is a diagram illustrating a device performing a method of measuring thermal conductivity of tissue, according to at least one embodiment.

Hereinafter, FIG. 4 is described with reference to the above-described drawings and overlapping descriptions with those described above are omitted.

Referring to FIG. 4, the device 10 may be attached to the surface of tissue 20 to measure thermal conductivity thereof. FIG. 4 as an example illustration may be an example of the device 10 of FIG. 2. Additionally, unlike the illustration in FIG. 4, the system 1000 of FIG. 1 itself may be attached to the surface of the tissue 20, instead of the device 10, to measure thermal conductivity thereof. In at least some embodiments, the device 10 and/or system 1000 may be physically held in place using, e.g., a contact adhesive, a wrap, etc., such that the temperature sensor 200 and the heating device 100 directly contact the tissue 20.

The device 10 may be configured to be attached to the surface of the tissue 20 through the heating device 100 such that a heat flow may be supplied in a direction perpendicular to the surface of the tissue 20. Additionally, the device 10 may be configured to generate temperature data by measuring the temperature of the surface of the tissue 20 through the temperature sensor 200.

FIG. 5A is a graph showing a first heat flow including constant heat flow according to at least one embodiment. FIG. 5B is a graph showing a second heat flow including a sinusoidal heating method according to at least one embodiment. FIG. 6 is a graph showing an example of sequentially applying a first heat flow and a second heat flow to tissue, according to at least one embodiment.

Hereinafter, FIGS. 5A, 5B, and 6 are described with reference to the above-described drawings and overlapping descriptions with those described above are omitted.

Referring to FIG. 5A, the heating device 100 may apply a first heat flow including constant heat flow to the tissue 20. The first heat flow according to at least one embodiment may be based on transient plane source method (TPSM). The constant heat flow may refer to constant heat flow regardless of time and the heating device 100 may generate the constant heat flow by using constant power for generating heat flow. By consuming power constantly, the heating device 100 may apply constant heat flow to the tissue 20 and the temperature of the surface of the tissue 20 may gradually increase.

Referring to FIG. 5B, the heating device 100 may apply a second heat flow including a sinusoidal heating method to the tissue 20. The sinusoidal heating may refer to heating that generates heat flow in a form, such as a sine function or a cosine function, over time. The heating device 100 may generate heat flow by consuming sinusoidal power for generating sinusoidal heat flow. By consuming sinusoidal power, the heating device 100 may apply sinusoidal heat flow to the tissue 20 and the temperature of the surface of the tissue 20 may also exhibit a time-delayed, sinusoidal form.

Referring to FIG. 6, the heating device 100 may apply first heat flow during a first time period and apply the second heat flow at a second time period different from the first. For example, the heating device 100 may sequentially apply the first heat flow including constant heat flow and the second heat flow including a sinusoidal heating method to the tissue 20. The system 1000 may apply different heat flows to the tissue 20 and measure temperature changes by applying both the first heat flow and the second heat flow through the heating device 100. The system 1000 may generate first temperature data corresponding to the first heat flow and second temperature data corresponding to the second heat flow through the temperature sensor 200.

Based on the first temperature data and the second temperature data, the system 1000 may derive the inherent thermal conductivity of the tissue 20 by considering heat transfer due to blood perfusion within the tissue 20. For example, the system 1000 may derive a first relationship through the computing device 300 by using the first temperature data corresponding to the first heat flow as a boundary condition in Penne's bioheat equation. Additionally, the system 1000 may derive a second relationship through the computing device 300 by using the second temperature data corresponding to the second heat flow as a boundary condition in Penne's bioheat equation. In at least some embodiments, the first relationship and the second relationship may be, respectively, represented by a first equation and a second equation. In at least some embodiments, the system 1000 may derive the inherent thermal conductivity of the tissue 20 from the first equation and the second equation through the computing device 300.

That is, the system 1000 may apply the constant heat flow and the sinusoidal heat flow to the tissue 20 by applying both the first heat flow and the second heat flow through the heating device 100. Additionally, the system 1000 may calculate the inherent thermal conductivity of the tissue 20 based on the first temperature data and the second temperature data.

According to the above-described embodiment, the inherent thermal conductivity of tissue itself may be measured by considering heat transfer due to blood perfusion without using invasive methods, such as incision or penetration. In addition, the inherent thermal conductivity of tissue may be derived by correcting the effect of heat transfer due to blood perfusion while performing in vivo thermal conductivity measurement.

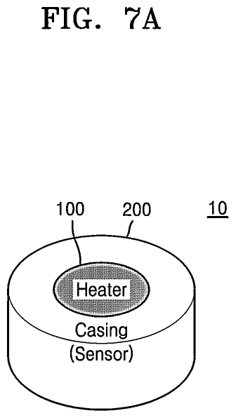

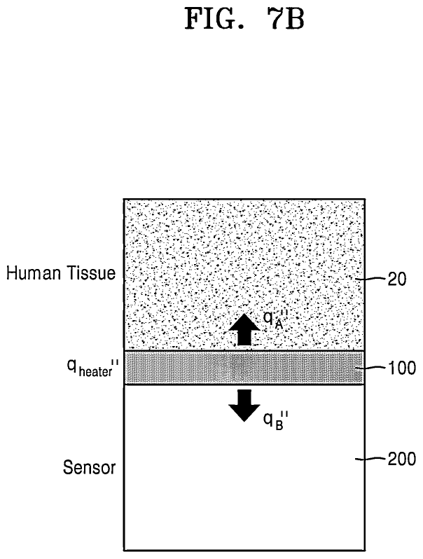

FIG. 7A is a diagram of a device according to at least one embodiment. FIG. 7B is a diagram showing heat flow due to heat generation of a device according to at least one embodiment.

Hereinafter, FIGS. 7A and 7B are described with reference to the above-described embodiments and overlapping descriptions with those described above are omitted.

Referring to FIG. 7A, the heating device 100 may be provided at one end of the device 10 and the temperature sensor 200 along with an insulating device may surround the heating device 100. The temperature actually measured by the temperature sensor 200 may include a temperature of the temperature sensor 200 (e.g., a temperature of a sensing portion of the temperature sensor 200 in contact with the measurement object). An integrated body including elements such as an insulating case including the temperature sensor 200 may share heat flow with the tissue 20 by coming into contact with the tissue 20. Accordingly, the integrated body including elements such as an insulating case including the temperature sensor 200 becomes the actual measurement object of the temperature sensor 200. Hereinafter, the integrated body may be collectively referred to as the temperature sensor 200 for convenience in terms of heat transfer analysis.

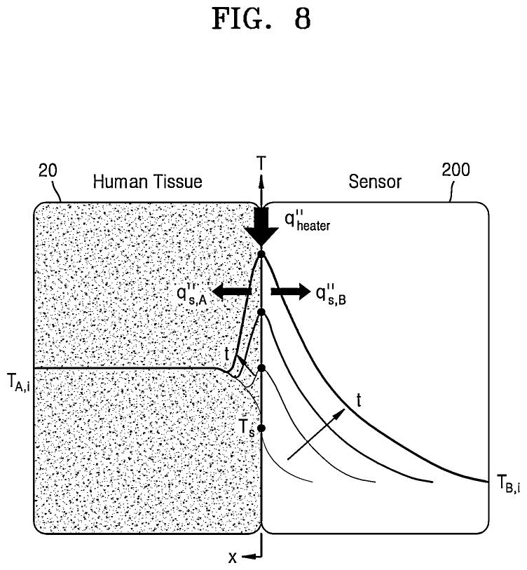

Referring to FIG. 7B, the temperature sensor 200 and the tissue 20 may share the heat flow applied from the heating device 100. That is, the heat flow qₕₑₐₜₑᵣ″ applied from the heating device 100 may be divided into heat flow q_{A}″ applied to the tissue 20 and heat flow q_{B}″ applied to the temperature sensor 200. In other words, not all of the heat flow qₕₑₐₜₑᵣ″ generated by the temperature sensor 200 is actually applied to the tissue 20 but the heat flow q_{A}″ which is part of the heat flow qₕₑₐₜₑᵣ″ is actually applied, leading to a temperature change in the tissue 20. The specific temperature change according to the gradient of heat flow may be described below with reference to FIG. 8.

FIG. 8 is a diagram showing a temperature change due to heat generation of a device according to at least one embodiment.

Hereinafter, FIG. 8 is described with reference to the above-described drawings and overlapping descriptions with those described above are omitted.

Referring to FIG. 8, the heat flow qₕₑₐₜₑᵣ″ applied from the heating device 100 may be divided into heat flow q_{A}″ applied to the tissue 20 and heat flow q_{B}″ applied to the temperature sensor 200. The heat flow may cause temperature changes in the tissue 20 and the temperature sensor 200, respectively. In addition, the heat flow q_{A}″ which is part of the heat flow qₕₑₐₜₑᵣ″ generated by the temperature sensor 200 may be actually applied to the tissue 20, resulting in a temperature change in the tissue 20. Referring to FIG. 8, as the heat flow q_{A}″ and the heat flow q_{B}″ are applied, the temperatures of the tissue 20 and the temperature sensor 200 may gradually increase over time. Specifically, the temperature of the surface of the tissue 20 (a part in contact with the temperature sensor 200) may rise rapidly. The temperature rise may become slower from the surface to the inner part of the tissue 20.

When the heat flow qₕₑₐₜₑᵣ″ applied from the heating device 100 is divided into the measurement object A and the temperature sensor B, the heat flow is affected by thermal diffusivity e and the equation therefor is denoted by Equation 4.

$${q}_{heater}^{″} = {q}_{A}^{″} + {q}_{B}^{″} \\ {q}_{A}^{″} = \frac{{e}_{A}}{{e}_{A} + {e}_{B}} {q}_{heater}^{″} \\ {q}_{B}^{″} = \frac{{e}_{B}}{{e}_{A} + {e}_{B}} {q}_{heater}^{″} \qquad [ Equation 4 ]$$

In Equation 4, e_{A} is a thermal diffusivity of the measurement object A and e_{A} is a thermal diffusivity of the temperature sensor B. Meanwhile, the thermal diffusivity may be configured as in Equation 5 below.

$$e = \sqrt{k ρ {c}_{p}} \qquad [ Equation 5 ]$$

When the thermal diffusivity is defined as a function regarding thermal conductivity k and the thermal conductivity or thermal diffusivity of the temperature sensor 200 itself can be measured or calculated, the heat flow q_{A}″ which is part of the heat flow qₕₑₐₜₑᵣ″ generated by the temperature sensor 200 and is actually applied to the tissue 20 may be calculated through Equation 4.

The thermal diffusivity of the temperature sensor 200 itself may be measured through test measurements on materials of which thermophysical information is known (e.g., glass, PDMS, resin, air, etc.). That is, the system 1000 may measure the thermal diffusivity of the temperature sensor 200 by measuring the thermal conductivity of materials of which thermophysical information is known, separately from (e.g., prior to) measuring the thermal conductivity of the tissue 20. In addition, the system 1000 may derive the heat flow q_{A}″ flowing into the tissue 20 from the heat flow qₕₑₐₜₑᵣ″ generated from the heating device 100 based on the thermal diffusivity of the temperature sensor 200. A value of the heat flow q_{A}″ flowing into the tissue 20 may be used to derive the inherent thermal conductivity of the tissue 20 through Penne's bioheat equation and the like described above.

For example, when the first heat flow including constant heat flow is applied to the tissue 20, a first equation may be derived using the first temperature data corresponding to the first heat flow as a boundary condition. The first equation which is a time-dependent response solution of the temperature of the surface of the tissue 20 may be expressed as Equation 6 below.

$$T ( x = 0 , t ) = [ \begin{matrix}\frac{A}{ω L} sinh ( ω L ) exp ( - {αω}^{2} t ) + \\ 2 \frac{A}{L} {\sum }_{n = 1}^{∞} ( \frac{ω sinh ( ω L ) + {λ}_{n} sin ( {λ}_{n} L )}{{ω}^{2} + {λ}_{n}^{2}} ) \\ exp ( - α ( {ω}^{2} + {λ}_{n}^{2} ) t ) + \\ \frac{1}{k ω} ( \frac{{q}_{m}^{′′′}}{ω} + {q}_{s}^{″} coth ( ω L ) ) + {T}_{a} ]\end{matrix} ] \qquad [ Equation 6 ]$$

$$where A = ( {θ}_{s} - \frac{{q}_{m}^{′′′}}{k {ω}^{2}} ) sech ( ω L ) - \frac{{q}_{s}^{″}}{k ω} csch ( ω L ) \\ α = \frac{k}{ρ {c}_{p}} , {λ}_{n} = \frac{n π}{L} , {ω}^{2} = \frac{{ω}_{b} {ρ}_{b} {c}_{p , b}}{k}$$

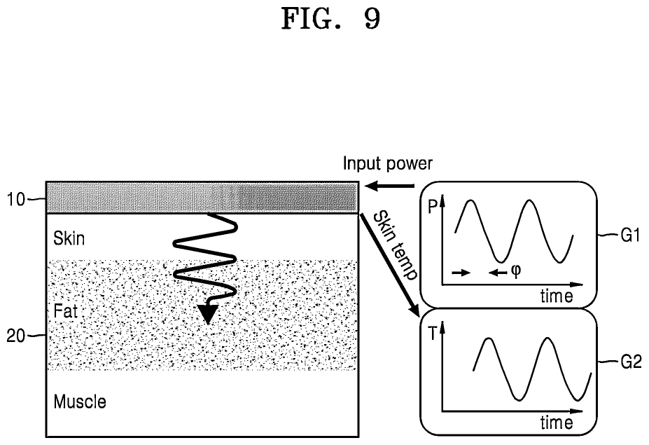

In Equation 6, w is an amount of blood perfusion, qₛ″ is a heat flow q_{A}″ applied from the surface, and L is a depth to the core according to the geometric structure of tissue. The analytical equation for the second heat flow including the sinusoidal heating method may be described below with reference to FIG. 9.

FIG. 9 is a diagram showing a temperature change due to application of a second heat flow to tissue according to at least one embodiment.

Hereinafter, FIG. 9 is described with reference to the above-described drawings and overlapping descriptions with those described above are omitted.

Referring to FIG. 9, the device 10 may apply the second heat flow including sinusoidal heat flow to the tissue 20. Specifically, a power graph G1 for heat generation of the heating device 100 in the device 10 may show a sinusoidal shape. Additionally, a second temperature data graph G2, which is data about the surface temperature of the tissue 20 corresponding to the second heat flow applied from the heating device 100, may also show a sinusoidal shape. The second temperature data graph G2 may be represented as a time-delayed response graph from the power graph G1. That is, the second temperature data graph G2 may have a phase difference q from the power graph G1.

For example, when the second heat flow including constant heat flow is applied to the tissue 20, a second equation may be derived using the second temperature data corresponding to the second heat flow as a boundary condition. The second equation, which is a time-dependent response solution of the surface temperature of the tissue 20, may be derived by a sinusoidal phase difference equation, according to at least one embodiment. That is, the equation for the sinusoidal phase difference between the second temperature data and the second heat flow may be expressed as Equation 7.

$$φ = arc tan ( \frac{sin ( \frac{γ}{2} )}{\frac{δ k \sqrt{A}}{{k}_{gap}} - cos ( \frac{γ}{2} )} ) \\ where A = \sqrt{{( \frac{{ω}_{b} {ρ}_{b} {c}_{p , b}}{k} )}^{2} + {( - \frac{ω}{α} )}^{2}} \\ γ = arc tan ( \frac{ω ρ {c}_{p}}{{ω}_{b} {ρ}_{b} {c}_{p , b}} ) \qquad [ Equation 7 ]$$

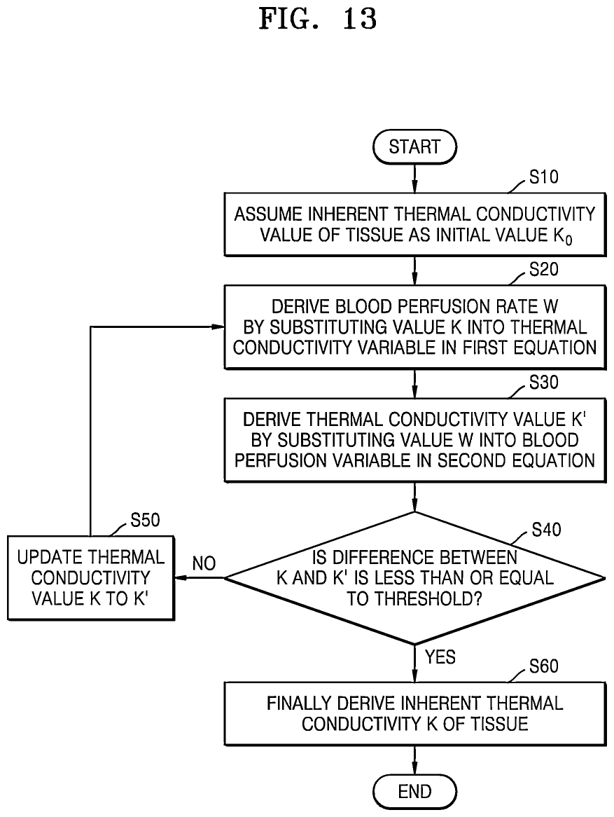

In Equation 7, 8 is a bondline thickness corresponding to the thermal contact resistance and k_{gap} is a thermal conductivity of the air. For example, the system 1000 may derive an approximate solution of the inherent thermal conductivity of the tissue 20 through numerical analysis from the first equation and the second equation. For example, the system 1000 may derive an approximate solution of the inherent thermal conductivity of the tissue 20 through numerical analysis from Equation 6 and Equation 7, representing, respectively, the first and second relationships. Numerical analysis may include various mathematical techniques, such as Fourier transform and Laplace transform, and methods of deriving approximate solutions, such as approximation estimation and confirmation of convergence values through repeated substitution. An example of deriving an approximate solution of inherent thermal conductivity may be described in detail below with reference to FIG. 13.

According to the above-described embodiment, the inherent thermal conductivity of tissue itself may be measured by considering heat transfer due to blood perfusion without using invasive methods, such as incision or penetration. In addition, the inherent thermal conductivity of tissue may be derived by correcting the effect of heat transfer due to blood perfusion while performing in vivo thermal conductivity measurement.

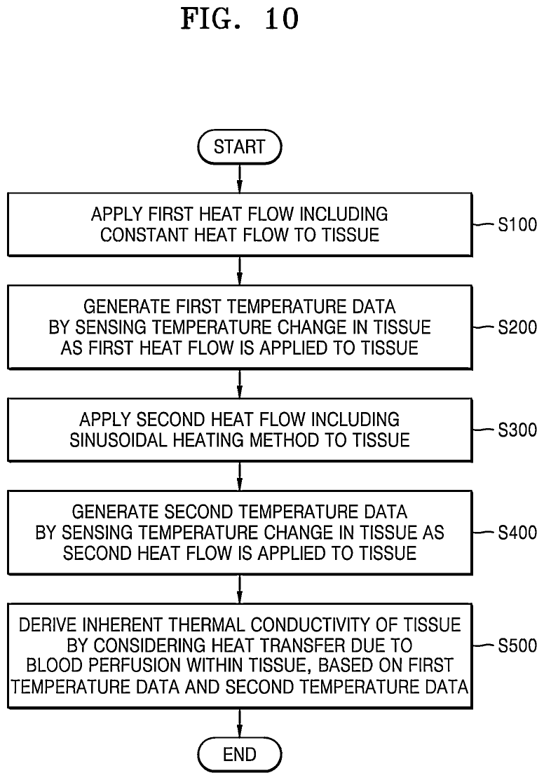

FIGS. 10 to 12 are flowcharts of a method of measuring thermal conductivity of tissue performed by a system 1000, according to at least one embodiment.

Referring to FIG. 10, the method of measuring thermal conductivity of tissue performed by the system 1000 may include a plurality of operations S100 to S500. Hereinafter, FIGS. 10 to 12 are described with reference to the above-described drawings and overlapping descriptions with those described above are omitted.

In operation S100, the system 1000 may apply the first heat flow including constant heat flow to the tissue 20. For example, the system 1000 may apply the first heat flow to the tissue 20 through the heating device 100.

In operation S200, the system 1000 may generate first temperature data by sensing the temperature change in the tissue 20 as the first heat flow is applied to the tissue 20. For example, the system 1000 may generate first temperature data by sensing the surface temperature of the tissue 20 over time through the temperature sensor 200. In other words, o operations S100 and S200 may overlap.

In operation S300, the system 1000 may apply the second heat flow including a sinusoidal heating method to the tissue 20. For example, the system 1000 may apply the second heat flow to the tissue 20 through the heating device 100.

In operation S400, the system 1000 may generate second temperature data by sensing the temperature change in the tissue 20 as the second heat flow is applied to the tissue 20. For example, the system 1000 may generate the second temperature data by sensing the surface temperature of the tissue 20 over time through the temperature sensor 200. In other words, operations S300 and S400 may overlap.

In operation S500, the system 1000 may derive the inherent thermal conductivity of the tissue 20 by considering heat transfer due to blood perfusion within the tissue 20, based on the first temperature data and the second temperature data. For example, the system 1000 may derive the inherent thermal conductivity of the tissue 20 through the computing device 300.

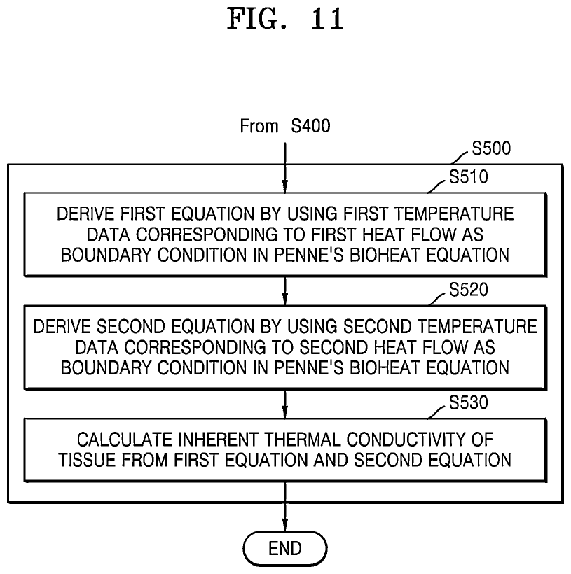

Referring to FIG. 11, operation S500 according to at least one embodiment may specifically include a plurality of operations S510 to S530.

In operation S510, the system 1000 may derive a first relationship, represented by, e.g., the first equation, using the first temperature data corresponding to the first heat flow as a boundary condition in Penne's bioheat equation. For example, the system 1000 may derive the first equation by using the first temperature data as a boundary condition in Penne's bioheat equation through the computing device 300. The first equation according to at least one embodiment may correspond to Equation 6.

In operation S520, the system 1000 may derive a second relationship, represented by, e.g., the second equation, using the second temperature data corresponding to the second heat flow as a boundary condition in Penne's bioheat equation. For example, the system 1000 may derive the second equation by using the second temperature data as a boundary condition in Penne's bioheat equation through the computing device 300. According to at least one embodiment, in operation S520, a sinusoidal phase difference between the second temperature data and the second heat flow may be derived. The second equation derived from the sinusoidal phase difference according to at least one embodiment may correspond to Equation 7.

In operation S530, the system 1000 may calculate the inherent thermal conductivity of the tissue 20 from the first equation and the second equation. For example, the system 1000 may calculate the inherent thermal conductivity of the tissue 20 from the first equation and the second equation through the computing device 300.

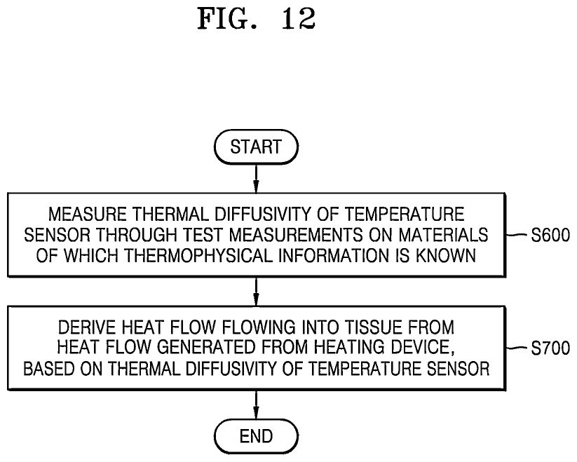

Referring to FIG. 12, the method of measuring thermal conductivity performed by the system 1000 may further include a plurality of operations S600 to S700. Operations S600 and S700 may be performed separately from the plurality of operations S100 to S500 of FIG. 10 and may be performed before or after the plurality of operations S100 to S500 of FIG. 10. For example, the system 1000 may perform operations S600 and S700 to derive the thermal diffusivity of the temperature sensor 200 prior to performing the plurality of operations S100 to S500.

In operation S600, the system 1000 may measure the thermal diffusivity of the temperature sensor 200 through test measurements on materials of which thermophysical information is known. For example, the system 1000 may generate test temperature data by sensing temperature changes through test measurements on materials of which thermophysical information is known through the temperature sensor 200 and may measure the thermal diffusivity of the temperature sensor 200 based on the received test temperature data through the computing device 300. Operation S600 may also be referred to as a calibration operation.

In operation S700, the system 1000 may derive the heat flow flowing into the tissue 20 from the heat flow generated from the heating device 100 based on the thermal diffusivity of the temperature sensor 200. For example, the system 1000 may derive the heat flow flowing into the tissue 20 from the heat flow generated from the heating device 100 based on the thermal diffusivity of the temperature sensor 200 through the computing device 300. Overlapping descriptions with those described with respect to the thermal diffusivity and the heat flow are omitted.

According to the above-described embodiment, the inherent thermal conductivity of tissue itself may be measured by considering heat transfer due to blood perfusion without using invasive methods, such as incision or penetration. In addition, the inherent thermal conductivity of tissue may be derived by correcting the effect of heat transfer due to blood perfusion while performing in vivo thermal conductivity measurement.

FIG. 13 is a flowchart of a method of measuring thermal conductivity of tissue performed by a system according to at least one embodiment.

Referring to FIG. 13, the method of measuring thermal conductivity performed by the system 1000 from the first equation and the second equation may include a plurality of operations S10 to S60. Hereinafter, FIG. 13 is described with reference to the above-described drawings and overlapping descriptions with those described above are omitted.

In operation S10, the system 1000 may assume the inherent thermal conductivity value k of the tissue 20 as an initial value k₀. The initial value k₀ may be a value stored as an internal variable and/or a value input from a user.

In operation S20, the system 1000 may derive the blood perfusion rate ω_{b} by substituting the value k into the thermal conductivity variable in the first equation. The first equation according to at least one embodiment may be based on Equation 6.

In operation S30, the system 1000 may derive an updated thermal conductivity value k′ by substituting the value ω_{b} derived from operation S20 into the blood perfusion variable in the second equation. The second equation according to at least one embodiment may be based on Equation 7.

In operation S40, the system 1000 may determine whether the difference between the original thermal conductivity value k and the updated thermal conductivity value k′ is less than or equal to a threshold. The threshold may be a value stored as an internal variable or a value input from the user. When the difference between the original thermal conductivity value k and the updated thermal conductivity value k′ is not less than or equal to the threshold, the system 1000 may perform operation S50. When the difference between the original thermal conductivity value k and the updated thermal conductivity value k′ is less than or equal to the threshold, the system 1000 may perform operation S60.

In operation S50, the system 1000 may update the inherent thermal conductivity value k to the value k′. Based on the updated inherent thermal conductivity value k′, the system 1000 may perform operation S20 again. The system 1000 may derive an approximate solution by repeatedly substituting the approximate solution into the equation until the inherent thermal conductivity value k converges to a difference below the threshold.

In operation S60, the system 1000 may finally derive the inherent thermal conductivity k of the tissue 20.

The iterative substitution method of FIG. 13 is a numerical analysis method according to at least one embodiment. The method of calculating the inherent thermal conductivity of the tissue 20 through numerical analysis from the first equation and the second equation may be derived by various mathematical methods.

According to the above-described embodiment, the inherent thermal conductivity of tissue itself may be measured by considering heat transfer due to blood perfusion without using invasive methods, such as incision or penetration. In addition, the inherent thermal conductivity of tissue may be derived by correcting the effect of heat transfer due to blood perfusion while performing in vivo thermal conductivity measurement.

While the inventive concepts have been particularly shown and described with reference to embodiments thereof, it will be understood that various changes in form and details may be made therein without departing from the spirit and scope of the following claims.

What is claimed is:

1. A method of measuring thermal conductivity of tissue using a device including a heating device and a temperature sensor, the method comprising:
applying a first heat flow to the tissue, the first heat flow including a constant heat flow;
generating first temperature data by sensing a temperature change in the tissue as the first heat flow is applied;
applying a second heat flow to the tissue, the second heat flow including a sinusoidal heat flow;
generating second temperature data by sensing a temperature change in the tissue as the second heat flow is applied; and
deriving inherent thermal conductivity of the tissue based on the first temperature data, the second temperature data, and heat transfer due to blood perfusion within the tissue.

2. The method of claim 1, wherein the deriving the inherent thermal conductivity of the tissue comprises:
deriving a first relationship using the first temperature data corresponding to the first heat flow as a first boundary condition in Penne's bioheat equation;
deriving a second relationship by using the second temperature data corresponding to the second heat flow as a second boundary condition in the Penne's bioheat equation; and
deriving the inherent thermal conductivity of the tissue based on the first relationship and the second relationship.

3. The method of claim 2, wherein the deriving of the second relationship comprises deriving a sinusoidal phase difference between the second temperature data and the second heat flow.

4. The method of claim 2, wherein the deriving the inherent thermal conductivity of the tissue comprises deriving an approximate solution of the inherent thermal conductivity of the tissue through numerical analysis based on the first relationship and the second relationship.

5. The method of claim 1, wherein the first heat flow is based on a transient plane source method (TPSM).

6. The method of claim 1, wherein the method measures the thermal conductivity of the tissue noninvasively.

7. The method of claim 1, wherein the method measures the thermal conductivity of the tissue in vivo.

8. The method of claim 1, further comprising:
measuring thermal diffusivity of the temperature sensor through test measurements on materials of which thermophysical information is known, and
deriving heat flow flowing into the tissue from heat flow generated from the heating device based on the thermal diffusivity of the temperature sensor.

9. A system for measuring thermal conductivity of tissue, the system comprising:
a heating device configured to apply a first heat flow including constant heat flow and a second heat flow including a sinusoidal heating method to the tissue;
a temperature sensor configured to generate first temperature data by sensing a temperature change in the tissue as the first heat flow is applied and to generate second temperature data by sensing a temperature change in the tissue as the second heat flow is applied; and
a computing device configured to derive inherent thermal conductivity of the tissue based on the first temperature data, the second temperature data, and heat transfer due to blood perfusion within the tissue.

10. The system of claim 9, wherein the computing device is further configured to:
derive a first relationship using the first temperature data corresponding to the first heat flow as a first boundary condition in Penne's bioheat equation;
derive a second relationship using the second temperature data corresponding to the second heat flow as a second boundary condition in the Penne's bioheat equation; and
derive inherent thermal conductivity of the tissue from the first relationship and the second relationship.

11. The system of claim 10, wherein the computing device is further configured to derive a sinusoidal phase difference between the second temperature data and the second heat flow.

12. The system of claim 10, wherein the computing device is further configured to derive an approximate solution of the inherent thermal conductivity of the tissue through numerical analysis based on the first relationship and the second relationship.

13. The system of claim 9, wherein the heating device configured to apply the first heat flow based on a transient plane source method (TPSM).

14. The system of claim 9, wherein the system is configured to measure the thermal conductivity of the tissue noninvasively.

15. The system of claim 9, wherein the system is configured to measure the thermal conductivity of the tissue in vivo.

16. The system of claim 9, wherein the computing device is further configured to
derive a thermal diffusivity of the temperature sensor based on test temperature data that has been derived by sensing temperature changes through test measurements on materials of which thermophysical information is known and,
derive the heat flow flowing into the tissue from heat flow generated from the heating device based on the thermal diffusivity of the temperature sensor.

17. A device for measuring thermal conductivity of tissue, the device comprising:
a heating device configured to apply a first heat flow including constant heat flow and a second heat flow including a sinusoidal heating method to the tissue;
a temperature sensor configured to generate first temperature data by sensing a temperature change in the tissue as the first heat flow is applied and to generate second temperature data by sensing a temperature change in the tissue as the second heat flow is applied; and
an interface circuit configured to transmit the first temperature data and the second temperature data to an outside computing device to enable the outside computing device to derive inherent thermal conductivity of the tissue based on the first temperature data, the second temperature data, and heat transfer due to blood perfusion within the tissue.

18. The device of claim 17, wherein the heating device is configured to apply the first heat flow based on a transient plane source method (TPSM).

19. The device of claim 17, wherein the device is configured to measure the thermal conductivity of the tissue noninvasively.

20. The device of claim 17, wherein the device is configured to measure the thermal conductivity of the tissue in vivo.
